(19) United States
(12) Patent Application Publication
(10) Pub. No.: US 2026/0368738 A1
(43) Pub. Date: Nov. 19, 2026

(54) SWARM INTELLIGENCE POWERED KOLMOGOROV ARNOLD NETWORK (KAN) BASED FRAUD DETECTION-PREVENTION-RESPONSE MECHANISM

(71) Applicant: Bank of America Corporation, Charlotte, NC (US)

(72) Inventors: Saurabh Gupta, New Delhi (IN); Wahid Hasan, Lucknow (IN); Barkha Tanwani, Jaipur (IN)

(21) Appl. No.: 19/210,021

(22) Filed: May 16, 2025

(51) Int. Cl. G06Q 20/40; G06N 3/045

(52) U.S. Cl. CPC G06Q 20/4016; G06N 3/045

(57) ABSTRACT

A method for providing a swarm-intelligence-powered Kolmogorov Arnold Network (KAN) based fraud detection-prevention-response mechanism is provided. The method includes detecting fraudulent transaction information stored in each of a threshold number of data repositories, using a mobile application programming interface associated with each of the threshold number of data repositories to derive one or more location codes associated with the fraudulent transaction information at each of the threshold number of data repositories, querying whether a user associated with a proposed transaction is located proximal to a region associated with the location codes and alerting the user associated with the proposed transaction information of the fraudulent transaction information at each of the data repositories within the region.

### FIELD OF THE DISCLOSURE

Aspects of this disclosure relate to fraud detection-prevention-response mechanisms.

### BACKGROUND OF THE DISCLOSURE

Bank customers face increasing threats of fraud due to the growing sophistication of cybercriminals and the expanding use of online and mobile banking services.

Fraudulent activities, including identity theft, phishing attacks, account takeovers, and unauthorized transactions. These fraudulent activities result in significant financial losses and erosion of customer trust.

Existing security measures, such as two-factor authentication and encryption, while effective to some extent, are still vulnerable. Specifically, these existing security measures are vulnerable to advanced tactics like social engineering, malware, and insider fraud.

The need for a more robust, proactive, solution to detect, prevent, and mitigate fraud is critical to safeguarding customers' financial assets and personal information.

The challenge is to develop a system or technology that can offer enhanced protection against fraud. It would be preferable if such a system could ensure real-time detection of fraud, reduce false positives, and provide seamless customer experience without compromising security.

### SUMMARY OF THE DISCLOSURE

A method for using a swarm-intelligence-powered Kolmogorov Arnold Network (KAN) based fraud detection-prevention-response mechanism is provided. The mechanism preferably improves real-time fraud response.

The mechanism may include a plurality of swarm-intelligence capable nodes. Each of the nodes is capable of providing fraud reporting to the central server. The central server is capable of broadcasting a report to each of the other of the plurality of swarm-intelligence capable nodes.

The mechanism may further include a plurality of network synapses. One or more of the synapses couple between each pair of the plurality of swarm-intelligence capable nodes. The fraud reporting received from the plurality of swarm-intelligence capable nodes is operable to form a pattern of fraudulent transaction history and store the pattern in one or more data repositories. The pattern may be leveraged for later use in building an anti-fraud strategy.

Each of the plurality of swarm-intelligence nodes is operable to provide a platform for per node fraud alert reporting, to the central server.

Fraud may be confirmed at a pre-determined node or in a pre-determined region. The confirmation of fraud may include fraud being confirmed pursuant to the fraud alert reporting and a follow-up investigation. The data repository is updated with the confirmed fraud reporting. Such updating may increase a weight in the network of each respective node included in the confirmed fraud reporting. Such updating may increase a weight in the network of each respective network synapse included in the confirmed fraud reporting.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus in accordance with principles of the disclosure;

FIG. 2 shows illustrative apparatus in accordance with principles of the disclosure;

FIG. 3 shows a schematic diagram for generating a swarm, and transactional incident reporting relating thereto, in accordance with the principles of the disclosure;

FIG. 4 shows a schematic diagram of potential fraud-prone locations, and various maps and descriptions associated therewith in accordance with the principles of the disclosure;

FIG. 5 shows an illustrative flow diagram in accordance with the principles of the disclosure; and

FIG. 6 shows a technical flow diagram of a KAN network in accordance with the principles of the disclosure.

### DETAILED DESCRIPTION OF THE DISCLOSURE

A system according to the disclosure provides a swarm-intelligence-powered Kolmogorov Arnold Network (KAN) based fraud detection-prevention-response mechanism. The mechanism improves real-time fraud response. The system includes a central server, a data repository and a KAN network.

The KAN network is formed from a plurality of swarm-intelligence capable nodes. Each of the nodes is capable of providing fraud reporting to the central server.

The central server can broadcasting a report to each of the other of the plurality of swarm-intelligence capable nodes. The report may include updated fraud information.

One or more of a plurality of network synapses may couple each pair of the plurality of swarm-intelligence capable nodes.

The central server may receive fraud reporting from the plurality of swarm-intelligence capable nodes.

The fraud reporting may form a pattern of fraudulent transaction history and store the pattern in the data repository. The pattern may be stored for later use in building an anti-fraud strategy. Such a strategy may set forth operative controls for governing the operation of the central server, the swarm-intelligence capable nodes and/or the fraud reporting. For example, one anti-fraud strategy may preferably temporarily electronically prevent all transactions within a predetermined proximity of a region determined to exhibit a threshold level of confirmed fraudulent activity.

Each of the plurality of swarm-intelligence nodes is operable to provide a platform for per node fraud alert reporting to the central server.

Once fraud is confirmed at a pre-determined node or in a pre-determined region such that the confirmation is confirmed pursuant to the fraud alert reporting and a follow-up investigation, the data repository is updated with the confirmed fraud reporting. The updating may include increasing a weight in the network of each respective node included in the confirmed fraud reporting, and increasing a weight in the network of each respective network synapse included in the confirmed fraud reporting.

The weight of each respective network synapse included in the confirmed fraud reporting is preferably at least in part proportional to a volumetric level, and/or a depth, of communication traffic between a plurality of endpoint nodes that form the endpoints coupled therebetween by the respective network synapse. Such depth may relate to the expanse of content in the communications under investigation.

The weight of each respective network synapse included in the confirmed fraud reporting is at least in part proportional to a level of severity of the confirmed fraud reporting. Such severity may include frequency and/or volume.

A fraud occurrence and severity associated with each of the plurality of nodes may correspond to a visual indicator on a network map electronic display of the KAN network.

The updating using the confirmed fraud reporting may further include using an application programming interface (API) to update the data repository, said updating the repository. Such updating may include updating the confirmed fraud reporting with a fraud score, fraud area or region and/or fraud amount.

Once fraud is confirmed pursuant to the fraud alert reporting and a follow-up investigation, each of the plurality of swarm-intelligence capable nodes within a pre-determined distance of the node may be further operable to receive each occurrence of the fraud reporting from the central server. Alternatively, each node may be further operable to receive a broadcast of the co-location of recent fraud generation activities. As such, all reports of fraud generated within a certain specified area or region may be broadcast to the nodes and put the nodes in a hi-alert status that the location of the frauds is currently producing a disproportionately large amount of fraudulent communications.

Proposed solutions, according to the embodiments, integrate Swarm Intelligence (SI) and Kolmogorov Arnold Network (KAN) technologies to create a proactive and responsive fraud detection and prevention system. The system(s), and associated method(s), enable real-time fraud reporting, geographic monitoring, and dynamic response management through collaborative data sharing among users. Such a sum of single-variable functions may serve to isolate nodes and/or synapses as disproportionately tied to fraud.

Such systems and methods effectively safeguard financial transactions. KANs are based on the KOLMGOROV-ARNOLD representation theorem, which serves as their mathematical foundation. The theorem states that any continuous multivariable function can be broken down into a sum of simpler, single-variable functions.

In some embodiments swarm intelligence may be used for real-time fraud reporting. Such swarm intelligence may be used to provide collaborative reporting. Preferably, substantially all customers in a defined geographical region can report suspected fraud in real-time, contributing to a shared knowledge base. This crowd-sourced information dynamically updates the fraud status for the region. Alternatively, all nodes that have been victimized by a certain region may cause an alert to go out that signifies that all communications from the certain region should be restricted, terminated or at the least put on alert. For example, associated proxy servers, IP addresses, or other location indicators associated with the region may be quarantined. While fraud-creating entities may spoof their respective location of origin, such spoofing may be overcome by terminating any communications that don't give up their origin information.

Certain embodiments may instantiate geographical fraud status. In some embodiments, each geographical location may be marked using a color-coded system such as, for example:
Red: High-fraud activity;
Yellow: Moderate fraud activity; and
Green: Safe zone.

Dynamic updates to the system may also be incorporated in certain embodiments. Accordingly, as new fraud reports are received by the system, the system preferably adjusts the fraud-reported level, according to the most recent fraud reports, preferably in real time, thereby enabling users to make informed decisions regarding system use.

Some embodiments may use Kolmogorov Arnold Network (KAN) for Fraud Analysis and Assessment. KAN fraud assessment may employ KAN to analyze fraud patterns. Such fraud assessment may consider historical and real-time data. Each transaction within a region is evaluated, and based on this analysis, the geographic region can be assigned a fraud risk color.

Initiation of KAN may be implemented for each transaction. Thus, for every transaction occurring within a geographic zone, the KAN model assesses the risk, weighing the fraud potential and adjusting the region's status in real time.

KAN weights based on fraud severity may include node weights. In KAN according to the embodiments, each geographical location is represented by a node. The weight of the node (and/or synapses) corresponds to the fraud level of that location, and may in certain embodiments include and/or show a visual indicator indicating the fraud level. For example, in one embodiment, red nodes indicate higher weights than yellow or green nodes.

KAN weights based on fraud severity may include synaptic weights. Synaptic weights involve weights given to connections between two nodes, in addition to the node weights given to each node individually. The connections (synaptic weights) between two geographical nodes may turn darker, or otherwise more intense, as fraud reports increase between those nodes. Such synaptic weights may indicate level of cross-regional fraud between two regions. For example, dark red synapses may indicate frequent fraud between two regions.

Light red synapses may indicate occasional fraud activity.

In some embodiments, the color of the synapses may visually represent a depth of the relationship between the two nodes connected at each end of the synapse. As such, a dark color may visually represent a synapse that supports a high level of communication between the nodes. Conversely, a light color may indicate a relatively lower level of communication between the two nodes.

In yet other embodiments, the color, or other visual indicator associated with the synapse, may visually indicate both a level of fraud and a depth of relationship between the two nodes.

In certain embodiments, the system continuously, or periodically, monitors changes in fraud activity, adjusting the KAN network's diagram. Swarm intelligence-driven reports trigger recalculations within KAN, obtaining, preferably in real-time, fraud status updates for each location.

Embodiments may also include systems for sending fraud alerts to customers. Once a region is marked as red or yellow based on KAN's assessment, alerts may be sent to nearby—i. e., within the region that is a target of fraud—customers, notifying them of potential fraud situations.

Reporting may report all fraudulent activities that are reported back to the entity for record-keeping, further analysis, and/or potential preventative measures in the future.

Not only does a KAN network according to the embodiments preferably assess real-time data but such a KAN network also incorporates past fraud data. Incorporation of past fraud data enables the KAN network to identify trends and patterns that predict future fraudulent activities.

Predictive markers may also be used in certain embodiments. For example, the evolving KAN synaptic weights may act as predictive markers for regions more likely to experience fraud in the future.

For the purposes of this application synaptic weights may be understood to symbolize learnable activation functions similar to or identical to “b-splines”—in a KAN network.

B-splines are used as activation functions—i.e., mathematical functions that are applied to the output of a neuron in a neural network, and which introduce non-linearity. Such functions typically enable the network to learn complex patterns. They determine whether a neuron should be activated or not, effectively deciding how much the signal from the neuron is passed on to the next layer.

B-splines may be used as activation functions in the following ways:

### Learnable Control Point:

B-splines are defined by control points, which are learnable parameters in KANs. The model adjusts the weights of these control points to determine the output values.

### Grid Structure:

B-splines are often defined over a grid of points, and the activation function is determined within each interval of the grid.

### Differentiability:

B-splines are differentiable, making them suitable for optimization using techniques like backpropagation.

Typically, B-splines are more interpretable than traditional activation functions.

Examples of B-spline activation functions in KANS include:

### Approximating Arbitrary Functions:

B-splines can be used to approximate substantially any continuous function.

Learning from Data:

The learnable coefficients of the B-spline are adjusted during training to fit the data and make accurate predictions.

### Interpretable Models:

The piecewise nature of B-splines makes it easier to understand the learned relationships in the model.

In essence, B-splines offer a powerful way to learn activation functions in neural networks, particularly within KANs, by leveraging their adaptability, differentiability, and interpretability.

Thus, the systems and methods set forth herein create a highly responsive fraud detection network that is driven by collective reporting and sophisticated network analysis. By harnessing the strengths of swarm intelligence and KAN, this technology ensures that both customers and entities, such as financial entities (FEs) are equipped with the tools needed to detect, prevent, and respond to fraud quickly and efficiently.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods. Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

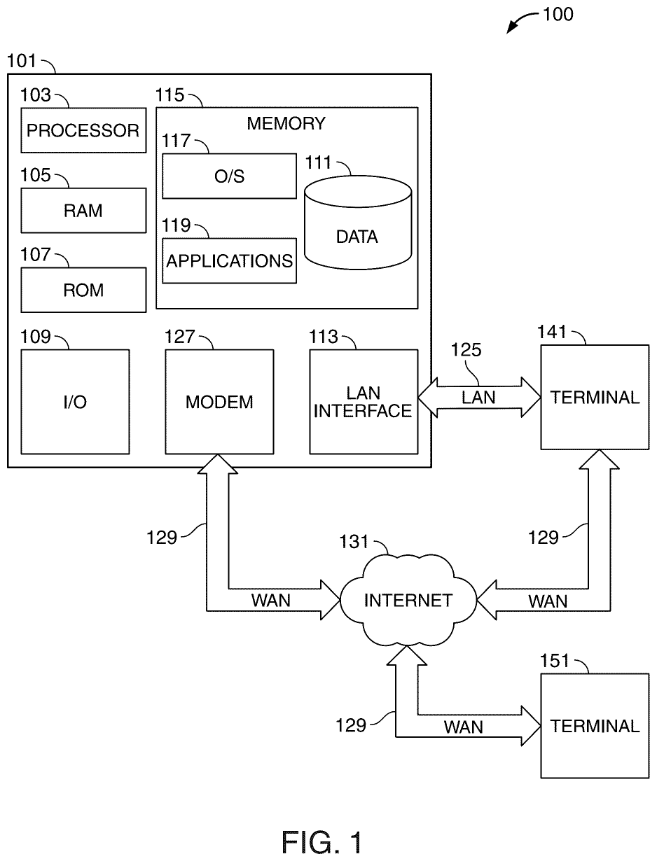

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute all software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

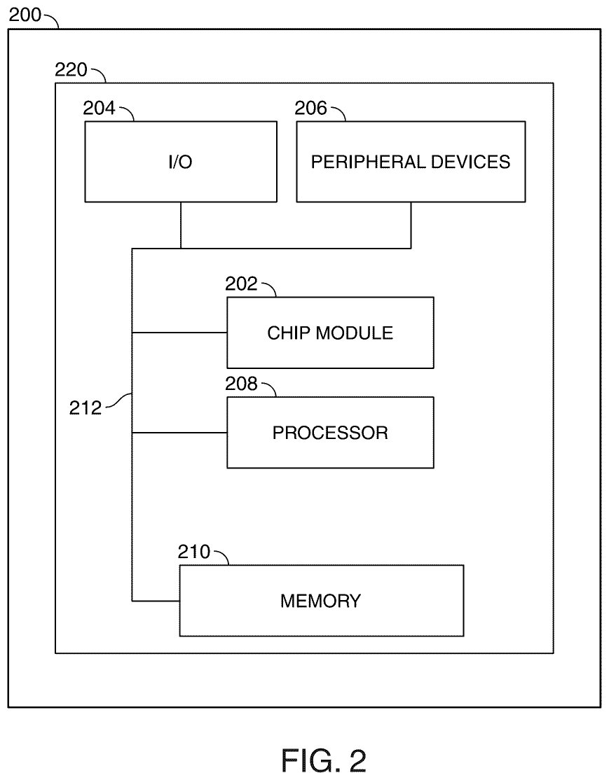

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

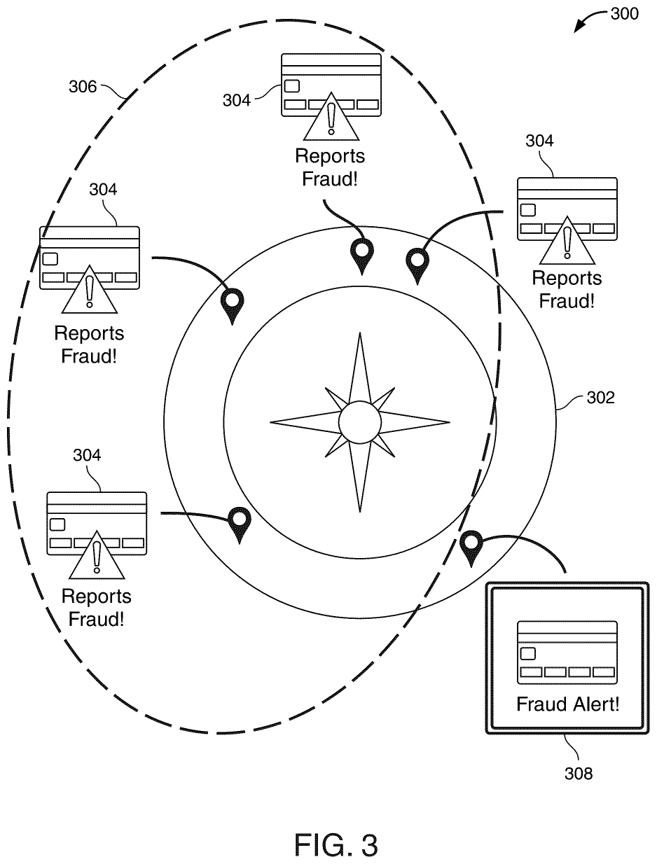

FIG. 3 shows a schematic diagram for generating a swarm and transactional incident reporting relating thereto. At 302, a symbolic geographic indicator 302 shows an environment in which fraud is currently, and somewhat constantly, occurring. Individually, swarm-reported, fraud events are identified at 304. Such swarm-reported events may put other customers on notice about actual, and potential, fraud occurrences.

Each of these occurrences 304 are preferably geographically marked so as to put the other members of the KAN on notice regarding the location of the current fraud. For example, within region 306 three of the four fraud of events are marked as having occurred. At 308, a fraud alert report is constructed for dissemination to other members of the swarm and/or an entity in control of the devices within the environment.

In embodiments, swarm intelligence may enable customers to report a potential or actual fraud in real time. Such a report may be broadcast, or made otherwise available, to other customers or users in the same, or in proximal, region(s) as the fraud.

In some embodiments, technology may be leveraged to mark the respective geographical location of the fraud as red, yellow or green based on the status and/or magnitude of the current fraud reported. Swarm intelligence may operate by empowering all customers to report and prevent fraud in real time.

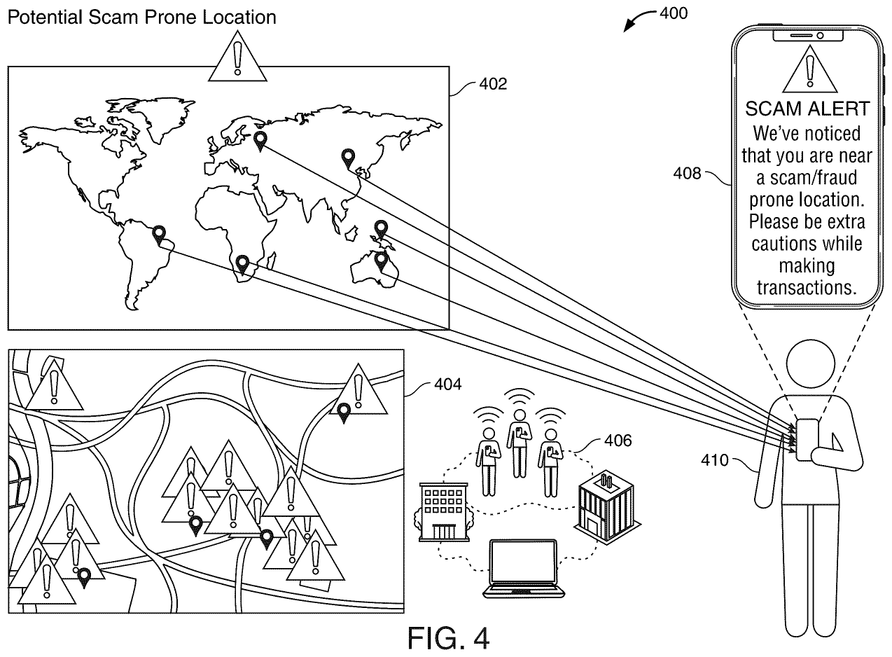

FIG. 4 shows a schematic diagram of potential fraud-prone locations, and various maps and descriptions associated therewith. At world map 402, numerous scam/fraud prone locations are shown. At local map 404, reports of fraud locations are indicated. At 406, an illustrative set of mobile device users, as well as mobile devices are shown. At the far right of FIG. 4, an exemplary fraud alert is shown on mobile device 408. Such an exemplary fraud alert may be broadcast to proximal users in the network.

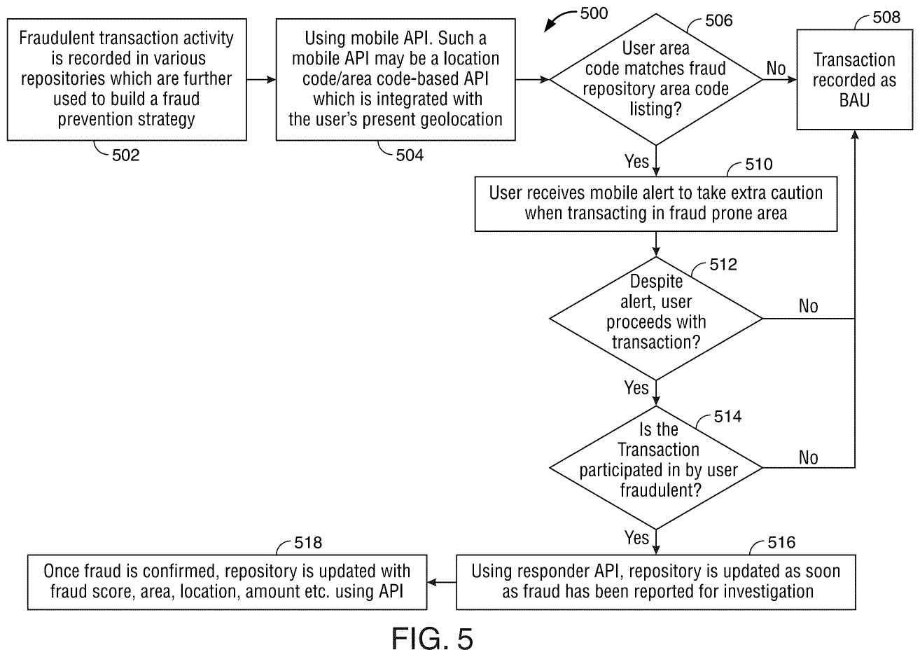

FIG. 5 shows an illustrative flow diagram 500 in accordance with the principles of the disclosure. At 502, fraudulent transactional activity is recorded in various repositories.

These repositories may be invoked to further build a fraud prevention strategy. At 504, the flow diagram shows using a mobile device based application programming interface (API). Such a mobile device based API may be location Code/Area Code based API which is integrated with the user's present geolocation.

At 506, the system may query whether the user area code (or other location code) matches a fraud repository area code listing. If the user area code does not match a fraud repository area code listing, then the transaction may be recorded, at 508, as low possibility of fraud—i.e., business as usual (BAU)—and be forwarded for further processing, which is explained below in further detail.

If the user area code does matches a fraud repository area code listing, then the transaction may be recorded as possibly fraudulent, and the system may alert the user, at 510, that the user should take extra caution when transacting in the fraud prone area.

At 512, the diagram queries whether the user has proceeded with the transaction, despite the alert transmitted to the user. The system then next queries whether the transaction participated in by the user, at 514, is a fraudulent transaction.

It should be noted that even when the user area code does not match the repository area code, suspected fraudulent transaction listing, as shown above in 506 and 508, the system still runs an independent check, at 514, as to whether the transaction participated in by the user is fraudulent.

When the transaction participated in by the user is determined to be fraudulent, then responder API is used to update, at 516, the repository. This updating occurs preferably as soon as fraud has been reported for investigation.

Once fraud is confirmed, at 518, the repository is updated with fraud level score, area, location, amount, etc. using the API.

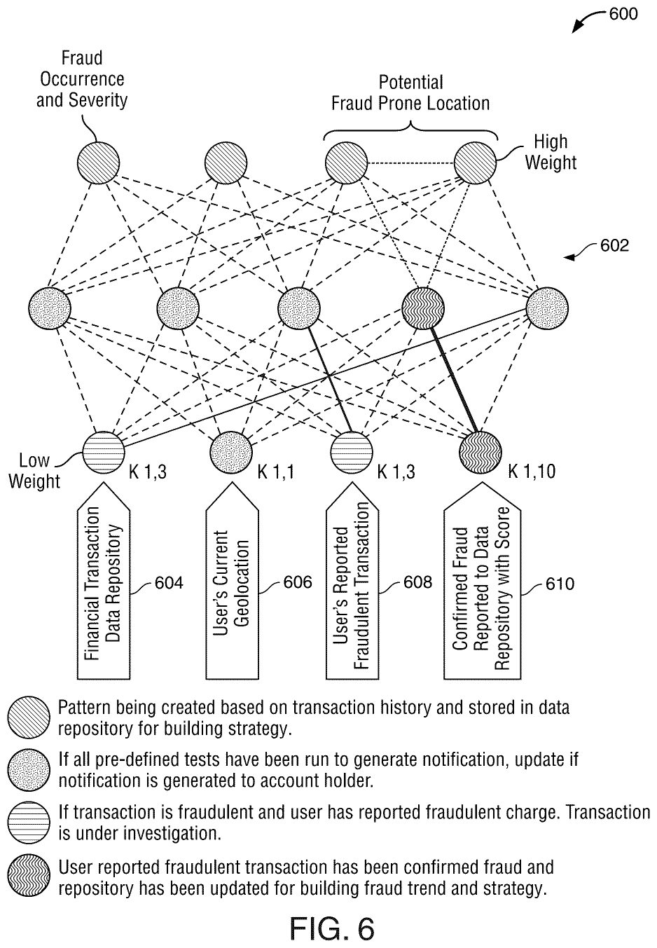

FIG. 6 shows a technical flow diagram of a KAN network in accordance with the principles of the disclosure. At network 602, individual network nodes are shown. Each row of nodes symbolizes a level different and declining (top to bottom) node weights. Each of the nodes includes a pre-determined pattern that corresponds to a discrete level of fraud occurrence as well as fraud severity. Furthermore-each of the nodes preferably corresponds to a potential fraud location.

Each node of the bottom-most row in the network may be used to define a certain part of the network. For example, node 604 shows a financial transaction data repository; node 606 shows a user's current geolocation; node 608 shows a user's reported fraudulent transaction; and node 610 shows confirmed fraud reported to data repository with score.

It should be noted that each of the low weight nodes are accompanied by a fraud occurrence and severity rating such as K 1,3, K 1,1, K 1,3 and K 1,10. At the K 1,1 patterns, the fraud occurrence and severity rating may show a lower number of frauds, and a lower synaptic weight between nodes. The synaptic weight may include an indication of a fraud connection between two connected nodes.

As such, b-spline between two geographical nodes may turn darker, or otherwise more intense, as fraud reports increase between those nodes. Such synaptic weights may indicate level of cross-regional fraud between two regions. For example, colors may be used to indicate severity of fraud between two nodes. For example, dark red synapses may indicate frequent fraud between two regions.

Light red synapses may indicate occasional fraud activity.

In some embodiments, the color of the synapses may visually represent a depth of the relationship between the two nodes connected at each end of the synapse. As such, a dark color may visually represent a synapse that supports a high level of communication between the nodes. Conversely, a light color may indicate a relatively lower level of communication between the two nodes. In some embodiments, the color may indicate both a depth of relationship and a level of fraudulent activity between the two nodes.

It should be noted further that each of the patterns shown in the nodes symbolize various actions to be taken in response to traversing the network. For example, a first pattern is based on transaction history and is stored in the data repository for building future strategy; a second pattern indicates that all pre-defined tests have been run to generate a notification, and the node condition may further updated to indicate that a notification has been generated for, and transmitted to, an account holder; a third pattern in which, if the charge or transaction is determined to be fraudulent, and the user has reported the fraudulent charge or transaction, then the transaction may be investigated; and, finally, when a user reported a fraudulent transaction and the transaction has been confirmed to be fraudulent, then the repository has been updated for discerning a fraud trend and building an anti-fraud strategy.

Thus, methods and apparatus for providing swarm intelligence powered Kolmogorov Arnold Network (KAN) based fraud detection-prevention-response mechanisms. Persons skilled in the art will appreciate that the present invention can be practiced by other than the described embodiments, which are presented for purposes of illustration rather than of limitation, and that the present invention is limited only by the claims that follow.

1. A system comprising one or more non-transitory computer-readable media storing computer-executable instructions which, when executed by a processor on a computer system, provides a swarm-intelligence-powered Kolmogorov Arnold Network (KAN) based fraud detection-prevention-response mechanism, said mechanism for improving real-time fraud response, said system comprising:
a central server;
a data repository;
a KAN network formed from:
a plurality of swarm-intelligence capable nodes, each of the plurality of swarm-intelligence capable nodes for providing fraud reporting to the central server;
wherein the KAN network is further operable to broadcast a report containing updated fraudulent transaction information, from the central server, to each of the other of the plurality of swarm-intelligence capable nodes;
a plurality of network synapses couple between each pair of the plurality of swarm-intelligence capable nodes;
wherein fraud reporting received from the plurality of swarm-intelligence capable nodes is operable to:
form a pattern of fraudulent transaction history and store said pattern in the data repository, said pattern for later use in building an anti-fraud strategy;
wherein each of the plurality of swarm-intelligence nodes is operable to provide a platform for per node fraud alert reporting, to the central server; and
wherein, once fraud is confirmed at a pre-determined node or in a pre-determined region, said confirmation being confirmed pursuant to the fraud alert reporting and a follow-up investigation, the data repository is updated with the confirmed fraud reporting, said updating comprising increasing a weight in the network of each respective node included in the confirmed fraud reporting, and increasing a weight in the network of each respective network synapse included in the confirmed fraud reporting.

2. The system of claim 1, wherein the weight of each respective network synapse included in the confirmed fraud reporting is at least in part proportional to a level of communication traffic between a plurality of endpoint nodes that form the endpoints coupled therebetween by the respective network synapse.

3. The system of claim 1, wherein the weight of each respective network synapse included in the confirmed fraud reporting is at least in part proportional to a level of severity of the confirmed fraud reporting

4. The system of claim 1, wherein a fraud occurrence and severity associated with each of the plurality of nodes corresponds to a visual indicator on a network map of the KAN network.

5. The system of claim 1, wherein the updating using the confirmed fraud reporting further comprising using an application programming interface (API) to update the data repository, said updating the repository comprising updating the confirmed fraud reporting with a fraud score, fraud area and/or fraud amount.

6. The system of claim 1, wherein, once fraud is confirmed pursuant to the fraud alert reporting and a follow-up investigation, each of the plurality of swarm-intelligence capable nodes within a pre-determined distance of the node at which the is further operable to receive each occurrence of the fraud reporting from the central server.

7. A method for providing a swarm-intelligence-powered Kolmogorov Arnold Network (KAN) based fraud detection-prevention-response mechanism, said method utilizing one or more non-transitory computer-readable media storing computer-executable instructions which, when executed by a processor on a computer system, said mechanism for improving real-time fraud response, said method comprising:
providing, using a plurality of swarm-intelligence capable nodes, fraud reporting to a central server;
broadcasting a report, from the central server, to each of the other of the plurality of swarm-intelligence capable nodes;
a plurality of network synapses couple between each pair of the plurality of swarm-intelligence capable nodes;
forming a pattern of fraudulent transaction history and store said pattern in a data repository, said pattern for later use in building an anti-fraud strategy;
providing a platform for per-node fraud alert reporting, to the central server; and
once fraud is confirmed at a pre-determined node or in a pre-determined region, said confirmation being confirmed pursuant to the fraud alert reporting and a follow-up investigation, updating a data repository with the confirmed fraud reporting, said updating comprising increasing a weight in the network of each respective node included in the confirmed fraud reporting, and increasing a weight in a KAN network of each respective network synapse included in the confirmed fraud reporting.

8. The method of claim 7, wherein the weight of each respective network synapse included in the confirmed fraud reporting is at least in part proportional to a level of communication traffic between a plurality of endpoint nodes that form the endpoints coupled therebetween by the respective network synapse.

9. The method of claim 7, wherein the weight of each respective network synapse included in the confirmed fraud reporting is at least in part proportional to a level of severity of the confirmed fraud reporting

10. The method of claim 7, wherein a fraud occurrence and severity associated with each of the plurality of nodes corresponds to a visual indicator on a network map of the KAN network.

11. The method of claim 7, wherein the updating using the confirmed fraud reporting further comprising updating using an application programming interface (API) to update the data repository, said updating the repository comprising updating the confirmed fraud reporting with a fraud score, fraud area and/or fraud amount.

12. The method of claim 7, wherein, once fraud is confirmed pursuant to the fraud alert reporting and a follow-up investigation, each of the plurality of swarm-intelligence capable nodes within a pre-determined distance of the node at which the is further operable to receive each occurrence of the fraud reporting from the central server.

13-17. (canceled)
